(19) United States
(12) Patent Application Publication
(10) Pub. No.: US 2017/0174980 A1
(43) Pub. Date: Jun. 22, 2017

(54) BIO-FIBER TREATMENT FLUID

(71) Applicant: Schlumberger Technology Corporation, Sugar Land, TX (US)

(72) Inventors: Hemant Kumar Jethalal Ladva, Missouri City, TX (US); Eric Metcalf-Doetsch, Wharton, TX (US)

(21) Appl. No.: 14/973,024

(22) Filed: Dec. 17, 2015

(51) Int. Cl. C09K 8/62; E21B 43/267; E21B 43/26; C09K 8/70

(52) U.S. Cl. CPC C09K 8/62; C09K 8/70; E21B 43/267; E21B 43/26; C09K 2208/08

(57) ABSTRACT

A treatment fluid containing bio-fibers composed of fibrous structural protein, such as keratin, which demonstrates the ability for proppant transport, resistance to degradation in the presence of many degradants, and selective degradation to other degradants. Methods of using the treatment fluid include introducing the treatment fluid in a well bore and selectively degrading one or more of the treatment fluid components.

### RELATED APPLICATIONS

None.

### BACKGROUND

The statements in this section merely provide background information related to the present disclosure and may not constitute prior art.

Many times in the oil industry, it is necessary and/or beneficial to include fibers in well treatment fluids for a variety of reasons. The art is desirous of treatment fluids comprising new and/or improved fibers, and new and/or improved methods employing such fibers.

### SUMMARY

The present disclosure is related to the use of bio-fibers in well treatment fluids. For example, animal based bio-fibers comprising fibrous structural protein such as modified and unmodified keratin bio-fibers can be used to enhance the properties of treatment fluids employed in oil and gas production including use in hydraulic fracturing.

There are numerous examples of fibrous structural proteins available from animal sources. Keratin fibers, for example, are found in human and animal hair and feathers. They tend to be non-abrasive, ecologically friendly, bio-degradable, insoluble in water and most solvents, thermally stable up to 100° C., have good mechanical properties and low cost. The instant disclosure is directed to utilizing or mimicking the structures and advantageous properties of fibrous structural proteins.

In embodiments a treatment fluid comprises a plurality of fibers comprising fibrous structural protein. In embodiments, the fibers comprise or are derived from keratin.

In embodiments, a method comprises dispersing a plurality of fibers comprising fibrous structural protein in a carrier fluid to produce or form a treatment fluid, and introducing or circulating the treatment fluid into a wellbore.

### DETAILED DESCRIPTION

For the purposes of promoting an understanding of the principles of the disclosure, reference will now be made to some illustrative embodiments of the current application. As used herein, the term “embodiment” refers to one or more non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

For exemplification, a substantial portion of the following detailed description is provided in the context of oilfield operations including fracturing, cementing, gravel packing, and the like. It is to be understood, however, that non-oilfield well treatment operations which can utilize and benefit from the instant disclosure are also intended.

The following conventions with respect to treatment fluid terms are intended herein unless otherwise indicated explicitly or implicitly by context.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of an aqueous solution wherein the carrier fluid comprises greater than 50 weight percent water, an oil based solution in which the carrier fluid comprises less than 50 weight percent water, an emulsion, slurry, or any other form as will be appreciated by those skilled in the art.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous fluid phases dispersed in the continuous phase, including any solutes, thickeners or colloidal particles, exclusive of other solid phase particles; reference to “water” in the slurry refers only to water and excludes any particles, solutes, thickeners, colloidal particles, etc.; reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein unless otherwise indicated refers to the apparent dynamic viscosity of a fluid at a temperature of 25° C. and shear rate of 170 s⁻¹. “Low-shear viscosity” as used herein unless otherwise indicated refers to the apparent dynamic viscosity of a fluid at a temperature of 25° C. and shear rate of 5.11 s⁻¹.

The term “dispersion” means a mixture of one substance dispersed in another substance, and may include colloidal or non-colloidal systems. The term “fines dispersion” refers to a dispersion of particles having particle diameters of 20 microns or smaller; “fines” refers to the dispersed particles in a fines dispersion. As used herein, “colloidal systems” comprise a dispersed phase having particle diameters of 20 microns or smaller uniformly dispersed in a continuous phase; “colloids” refers to the dispersed particles in a colloid system. The terms “fines emulsion”, “sol”, “hydrosol” (where the continuous phase is aqueous) and “colloidal emulsion” are used interchangeably herein to refer to colloidal systems with solid and/or liquid particles dispersed therein.

As used herein, “emulsion” generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase.

As used herein unless otherwise specified, as described in further detail herein, particle size and particle size distribution (PSD) mode refer to the median volume averaged size. The median size used herein may be any value understood in the art, including for example and without limitation a diameter of roughly spherical particulates. In an embodiment, the median size may be a characteristic dimension, which may be a dimension considered most descriptive of the particles for specifying a size distribution range.

As used herein, the term “packing volume factor” or “packed volume fraction”, abbreviated “PVF” refers to the packed volume fraction of a randomly packed mixture of solids having a multimodal volume-averaged particle size distribution.

As used herein, the terms “Apollonianistic,” “Apollonianistic packing,” “Apollonianistic rule,” “Apollonianistic particle size distribution,” “Apollonianistic PSD” and similar terms refer to a multimodal volume-averaged particle size distribution with PSD modes that are not necessarily strictly Apollonian wherein either (1) a first PSD mode comprises solids having a volume-averaged median size at least one and a half larger (1.5×), or at least three times larger (3×) than the volume-average median size of at least a second PSD mode such that a PVF of the solids mixture exceeds 0.75 or (2) the solids mixture comprises at least three PSD modes, wherein a first amount of particulates have a first PSD, a second amount of particulates have a second PSD, and a third amount of particulates have a third PSD, wherein the first PSD is from two to ten times larger than the second PSD, and wherein the second PSD is at least 1.5 times larger than the third PSD. High solids content fluids (HSCF) typically comprise a plurality of Apollonianistic particle size distribution modes.

As used herein, a “water soluble polymer” refers to a polymer which has a water solubility of at least 5 weight percent (0.5 g polymer in 9.5 g water) at 25° C.

As used herein, aspect ratio refers to the ratio of the longest axis of a particle to the shorter axis of the particle orthogonal to the longest axis. In simpler terms, the aspect ratio is the length divided by the width and expressed as a unit less ratio. Accordingly, a particle having a circular cross section and a perfectly square particle have an aspect ratio of 1.

As used herein, a “fiber” refers to a particle having an elongated shape such as a thread or filament. For purposes herein, a fiber has a minimum aspect ratio of 5.

A fibrous structural protein refers to an elongated molecule having a secondary structure e.g., an alpha helix, beta pleated sheets, and the like, which forms the dominant structure of the molecule. Fibrous structural proteins are insoluble, and play a structural or supportive role in the living organism which produced them. Fibrous structural proteins may also include regular repeating structures. Animal based fibrous structural proteins include keratin found in hair, horns, wool, nails, and feathers. Keratin comprises a helix or helices in which two pairs of alpha-helices are wound around one another. The peptide from which these helices are made has a seven amino acid repeating structure. Silk is another example of an animal-based fibrous structural protein comprised of beta-sheets and having a repeating pattern of layers of glycine alternate with layers of alanine and serine in the beta-sheets. Collagen is also a fibrous structural protein and includes a repeating pattern in which every third amino acid is glycine and many of the others are proline. Fibroin is a fibrous structural protein found in silk cloth and spider webs.

As used herein, fibrous structural proteins may be derived from a natural source, e.g., a mammalian source such as hair, or may be synthetically produced to chemically and structurally resemble structural proteins found in nature, which is referred to herein as being derived from a synthetic source. For purposes herein, a substituted fibrous structural protein is a fibrous structural protein which has been chemically modified e.g., functionalized. A partially hydrolyzed fibrous structural protein, e.g., partially hydrolyzed keratin, has been reacted with an acid or base under hydrolysis conditions, but still retains the properties of a fibrous structural protein. In other words, it is to be understood that a partially hydrolyzed fibrous structural protein in general, and a partially hydrolyzed keratin in particular, does not refer to hydrolyzed keratin as described in U.S. Pat. No. 6,547,871, which is incorporated herein by reference.

In embodiments, a treatment fluid comprises a plurality of fibers comprising fibrous structural protein. In embodiments, the treatment fluid comprises structural protein fibers as described herein and proppant in a viscous carrier fluid. In embodiments, the fibers comprise keratin derived from one or more synthetic sources, one or more mammalian sources, or a combination thereof. In embodiments, the fibers comprise a substituted keratin protein, an unsubstituted keratin protein, a partially hydrolyzed keratin protein, or a combination thereof. In embodiments, the fibers have an average particle size distribution from 0.1 mm to 100 mm. In embodiments, the fibers comprise an average aspect ratio greater than 5, or from about 5 to about 10,000. In embodiments, the fibers have an average length from about 0.1 mm to about 100 mm. In embodiments the fibers may be straight or crimped. In embodiments the fibers are nano keratin fibers having an average length from about 1 to 10 microns and a diameter of from 2 to 100 nm.

In embodiments, the treatment fluid may further comprise a dispersant, a surfactant, a viscosifier, a viscoelastic surfactant, a defoamer, a pH control agent, a cross-linker, a cross-linking delay agent, a gel stabilizer, an emulsion, a breaker, or a combination thereof. In embodiments, the treatment fluid comprises guar, diutan, xanthan, hydroxyethylcellulose, carboxymethyl cellulose, nano cellulose, carboxymethylhydroxypropyl guar, or a combination thereof. In embodiments, the treatment fluid comprises a proppant.

In embodiments, the treatment fluid comprises a foam, an energized fluid, or a combination thereof. In embodiments, the foam comprises a gas component selected from the group consisting of nitrogen, air, carbon dioxide, hydrocarbons, and mixtures thereof. In embodiments, the gas component comprises from about 5 volume percent to about 95 volume percent of the treatment fluid.

In embodiments, the fibers comprising fibrous structural protein are present in the treatment fluid an amount sufficient to inhibits proppant settling and/or act as a carrier and/or facilitate transport of the proppant during subterranean treatment of a formation. In embodiments, the treatment fluid may be a fracturing fluid, a cementing fluid, a drilling fluid, a sand control fluid, and/or the like.

In embodiments, at least a portion of the fibers comprising fibrous structural protein may be only partially hydrolyzed thereby increasing the viscosity of the treatment fluid in addition to facilitating transport of proppant, prevent proppant flowback, forming in-situ channelization, plugging perforation tunnels, functioning as an additive for diversion, or a combination thereof.

In some embodiments, the treatment fluid comprises from 1 to 500 ppt by weight (pounds per thousand gallons of clean carrier fluid) of the fibers comprising fibrous structural protein, based on the total amount of carrier fluid present. In embodiments, the fibers comprising fibrous structural protein are present in the treatment fluid at a concentration of greater than or equal to about 10 ppt, or greater than or equal to about 20 ppt, or greater than or equal to about 30 ppt, or greater than or equal to about 40 ppt, or greater than or equal to about 50 ppt, or greater than or equal to about 60 ppt, or greater than or equal to about 100 ppt, or greater than or equal to about 200 ppt, based on the total volume of the carrier fluid present.

In embodiments, the treatment fluid comprises keratin derived from an animal source. In embodiments, the treatment fluid comprises keratin derived from one or more mammalian sources, a synthetically derived keratin, a substituted keratin (i.e., chemically modified keratin), a partially hydrolyzed keratin, or a combination thereof. In embodiments, the treatment fluid comprises a keratin derived from a plurality of mammalian sources. For example, a treatment fluid may include a portion comprising the more flexible and elastic α-keratins derived from hair, having fewer inter-chain disulfide bridges than the more rigid β-keratins derived from mammalian fingernails, hooves and claws. Hair and other α-keratins typically include α-helically coiled single protein strands (with regular intra-chain H-bonding), which are then further twisted into superhelical ropes that may be further coiled. However, different species have different α-keratins and thus, different properties. Accordingly, in embodiments, the treatment fluid may comprise keratin fibers derived from different animal sources (having different characteristics). In embodiments, the treatment fluid may comprise keratin fibers derived from different animal sources which have been selected to produce a blend of keratin fibers to produce a treatment fluid having a particular range of properties to address a particular end use.

In embodiments, the treatment fluid may further comprise fibers selected from the group consisting of polylactic acid (PLA), polyglycolic acid (PGA), polyethylene terephthalate (PET), polyester, polyamide, polycaprolactam and polylactone, poly(butylene) succinate, polydioxanone, nylon, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, cellulose and other natural fibers, rubber, and combinations thereof.

In embodiments, the fibers may be a composite fiber comprising keratin and a further component such as for example one or more polyesters.

In some embodiments, the carrier fluid may be slickwater, or may be brine. In some embodiments, the carrier fluid may comprise a linear gel, e.g., water soluble polymers, such as hydroxyethylcellulose (HEC), guar, copolymers of polyacrylamide and their derivatives, e.g., acrylamido-methyl-propane sulfonate polymer (AMPS), or a viscoelastic surfactant system, e.g., a betaine, or the like. When a polymer is present, it may be at a concentration below about 20 ppt. When a viscoelastic surfactant is used, it may be used at a concentration below about 20 ppt.

In some embodiments the treatment fluid may include a fluid loss control agent, e.g., fine solids less than 10 microns, or ultrafine solids less than 1 micron, or 30 nm to 1 micron. According to some embodiments, the fine solids are fluid loss control agents such as γ-alumina, colloidal silica, CaCO₃, SiO₂, bentonite etc.; and may comprise particulates with different shapes such as glass fibers, flocs, flakes, films; and any combination thereof or the like. Colloidal silica, for example, may function as an ultrafine solid loss control agent, depending on the size of the micropores in the formation, as well as a gellant and/or thickener in any associated liquid or foam phase.

In some embodiments, the carrier fluid comprises brine, e.g., sodium chloride, potassium bromide, ammonium chloride, potassium chloride, tetramethyl ammonium chloride and the like, including combinations thereof. In some embodiments the fluid may comprise oil, including synthetic oils, e.g., in an oil based or invert emulsion fluid.

In some embodiments, the treatment fluid comprises a friction reducer, e.g., a water soluble polymer. The treatment fluid may additionally or alternatively include, without limitation, clay stabilizers, biocides, crosslinkers, breakers, corrosion inhibitors, temperature stabilizers, surfactants, and/or proppant flowback control additives. The treatment fluid may further include a product formed from degradation, hydrolysis, hydration, chemical reaction, or other process that occur during preparation or operation.

In some embodiments, a method to treat a subterranean formation penetrated by a wellbore, comprises injecting the treatment fluid described herein into the subterranean formation to form a hydraulic fracture system, and maintaining a rate of the injection to avoid bridging in the wellbore, such as, for example, as determined in a bridging testing apparatus without proppant.

In some embodiments, the method may comprise injecting a pre-pad, pad, tail or flush stage or a combination thereof. In some embodiments, the treatment fluid used in the method comprises the treatment fluid described above.

The treatment fluid may be prepared using blenders, mixers and the like using standard treatment fluid preparation equipment and well circulation and/or injection equipment. In some embodiments, a method is provided to inhibit proppant settling in a treatment fluid circulated in a wellbore, wherein the treatment fluid comprises the proppant dispersed in a low viscosity carrier fluid. The method comprises dispersing fiber in the carrier fluid in an amount effective to inhibit settling of the proppant, such as, for example, as determined in the small slot test, and maintaining a rate of the circulation to avoid bridging in the wellbore, such as, for example, as determined in a bridging testing apparatus without proppant and/or in the narrow fracture flow test. In some embodiments, the treatment fluid further comprises a friction reducer.

In an embodiment, a treatment fluid comprises a solids mixture comprising a plurality of particles comprising a plurality of volume-average particle size distribution (PSD) modes such that a packed volume fraction (PVF) of the solids mixture exceeds 0.8. In another embodiment, the smaller PSD modes comprise hydrolyzable or otherwise removable particles. In embodiments, at least a portion of these removable particles includes the bio-fibers comprising the fibrous structural protein, which can be removed from a pack formed by the treatment fluid to increase porosity and permeability of the pack and therefore, increase the flow of fluids through the pack.

It has been discovered that keratin fibers do not degrade by contact with an oxidizer or in relatively concentrated acid, e.g., 7.5 weight percent HCl after 2 days at 25° C. In embodiments, this unique property of keratin is exploited in various oilfield applications where such aggressive fluids are used, e.g. acid treatments in carbonates or acid used in unconventional shale gas. Also, in application for in-situ channelization, it is beneficial to maintain fiber integrity while breaking the carrier fluid, which is usually done with an oxidizing breaker.

In embodiments, the fibers comprising fibrous structural protein are contacted with an appropriate degradation material at a concentration and for a period of time sufficient to remove at least a portion of the fibers from any pack formed therewith, improving fluid transport there through. It has been discovered that the keratin fibers may be degraded by contact with various alkaline compounds or solutions, e.g., alkali metal oxides and hydroxides such as NaOH. This previously unknown attribute of treatment fluids containing keratin fibers is very beneficial, as it allows for very effective cleanup of fibers from the wellbore. In embodiments, the degradation of the fibers may occur after fracture closure, and may be adjustable by altering the concentration and/or the composition of the degrading material.

In embodiments, the bio-fibers are selected which slowly degrade upon contact with an appropriate degradation material such that they may support the proppant during pumping, and then are dissolved after job completion. This results in increased permeability of the proppant pack during production, which leads to increased conductivity and production for the entire fracture. This is beneficial for all well treatments in which fibers may be employed. Examples include in-situ channelization, as this property of the bio-fibers allows for conductivity through the proppant pillars in addition to the channels formed.

In embodiments, the treatment fluid comprises an Apollonianistic solids mixture, wherein at least one particle size distribution mode comprises the fibers. In embodiments, the Apollonianistic solids mixture comprises first and second particle size distribution modes wherein the first particle size distribution mode is from 1.5 to 2.5 times larger than the second particle size distribution mode and wherein the first particle size distribution mode is smaller than a particle size distribution mode of a proppant.

In an embodiment, the Apollonianistic mixture of particles comprising first and second particle size distribution modes wherein the first particle size distribution mode is at least 1.5 times larger, or at least 3 times larger, or from about 1.5 to 25 times larger, or about 3 to 20 times larger, or about 3 to 15 times larger, or about 7 to 10 times larger, or about 1.5 to 2.5 times larger than the second particle size distribution mode. In an embodiment, the particles comprise a degradable polymer, which comprises at least one particle size distribution mode of the Apollonianistic mixture of particles. In embodiments, one of the distribution modes of the Apollonianistic particle size distribution comprises the fibers comprising fibrous structural protein, which in embodiments, is a bio-fiber comprising, consisting of, or consisting essentially of keratin.

In an embodiment, the treatment fluid may include a mixture or blend of at least two polymers or copolymers comprising more than 1 weight percent of each component. The two polymers in the blend may be miscible i.e., thermodynamically stable with a negative Gibbs free energy; or immiscible i.e., having a positive Gibbs free energy.

In an embodiment, the treatment fluid may further include various sized particles, which may include micron or submicron sized particles such as, for example, silicates, γ-alumina, MgO, γ-Fe₂O₃, TiO₂ and combinations thereof; hydratable polymer particles, e.g., polymer particles having a hydration temperature above 60° C. such as gellan gum; high aspect ratio particles, e.g. having an aspect ratio above 6, such as, for example, flakes or inorganic fibers; and/or a plurality of different types of degradable particles.

In embodiments, the treatment fluid may include a stabilizer agent, which may be an anionic surfactant, selected to stabilize one or more of the particles upon dilution of the dispersion in a carrier fluid.

In an embodiment, the treatment fluid may include one or more surfactants. In embodiments, the treatment fluid may include a nonionic surfactant, which may be one or more of alkyl alcohol ethoxylates, alkyl phenol ethoxylates, alkyl acid ethoxylates, alkyl amine ethoxylates, sorbitan alkanoates, ethoxylated sorbitan alkanoates, or the like. The nonionic surfactant in one embodiment may be an alkoxylate such as octyl phenol ethoxylate or a polyoxyalkylene such as polyethylene glycol or polypropylene glycol, or a mixture of an alkoxylate or a plurality of alkoxylates with a polyoxyalkylene or a plurality of polyoxyalkylenes, e.g., a mixture of octyl phenol ethoxylate and polyethylene glycol.

In embodiments, the treatment fluid may include a wax, oil-soluble resin, materials soluble in hydrocarbons, lactide, glycolide, aliphatic polyester, poly(lactide), poly(glycolide), poly(ε-caprolactone), poly(orthoester), poly(hydroxybutyrate), aliphatic polycarbonate, poly(phosphazene), poly(anhydride), poly(saccharide), dextran, cellulose, chitin, chitosan, protein, poly(amino acid), poly(ethylene oxide), and copolymers including poly(lactic acid).

In embodiments, the treatment fluid may further comprise from about 0.01 weight percent to about 50 weight percent of a dispersant, a surfactant, a viscosifier, a viscoelastic surfactant, a defoamer, a pH control agent, a cross-linker, a cross-linking delay agent, a gel stabilizer, an emulsion, a breaker, or a combination thereof.

In embodiments, the treatment fluid may comprise from about 0.01 weight percent to about 50 weight percent guar, diutan, xanthan, hydroxyethylcellulose, carboxymethyl cellulose, carboxymethylhydroxypropyl guar, or a combination thereof.

In embodiments, the treatment fluid may comprise from about 0.01 weight percent to about 50 weight percent of one or more water soluble polymers having a water solubility of greater than or equal to about 5 weight percent at 25° C. Suitable water soluble polymers include polyvinyl alcohol, polyethylene oxide, sulfonated polyester, polyacrylic ester/acrylic acid copolymer, polyacrylic ester/methacrylic acid copolymer, polyethylene glycol, poly (vinyl pyrrolidone), polylactide-co-glycolide, ethyl cellulose, hydroxypropylcellulose, hydroxypropyl methylcellulose, aminomethacrylatecolpolymer, polydimethlyaminoethylmethacrylate-co-methacrylicester, polymethacyrlicacid-co-methylmethacrylate, guar, hydroxyethylcellulose, xanthan, or a combination thereof.

The treatment fluid as described herein, in some embodiments, is used in a method comprising, for example, dispersing a plurality of fibers comprising fibrous structural protein in a carrier fluid to form a treatment fluid, and passing the treatment fluid downhole through a wellbore. In some embodiments, the method comprises transporting the proppant and another solid in the treatment fluid. In some embodiments, the method comprises dispersing a degradable material into the treatment fluid, and selectively degrading one of the degradable material and the fibers downhole.

In some embodiments, the method comprises dispersing a degradable material into the treatment fluid, selectively degrading one of the degradable material and the fibers downhole, and then degrading the other one of the degradable material and the fibers.

In some embodiments of the method, the fibers comprise partially hydrolyzed keratin to viscosify the treatment fluid. In embodiments the viscosifier is a nano keratin fibers.

In some embodiments, the method comprises passing downhole through a wellbore a treatment fluid comprising keratin fibers, proppant and a viscosifying agent in a carrier fluid; and degrading the viscosifying agent downhole. In some embodiments, the method comprises distributing a mixture of the fibers and proppant into one or more regions in a fracture, e.g., wherein the viscosifying agent induces in situ channelization to aggregate the mixture into pillars in the one or more regions separated by channels. In some embodiments, the method comprises producing reservoir fluid through the channels between pillars of the aggregated mixtures, e.g., without degrading the keratin fibers.

In situ channelization treatment fluids and methods, in which the fibers according to the present disclosure may be used, and/or which may be adapted for use of the fibers disclosed herein, are described, for example, in U.S. Pat. Pubs. US 2015/0053403 and US 2015/0060063, and US2014/0262264, which are hereby incorporated herein by reference in their entirety.

In some embodiments, the method comprises forming a proppant pack comprising the keratin fibers, and degrading the fibers to increase permeability of the proppant pack.

In some embodiments, the viscosifying agent used in the method comprises a polymer described above, e.g., selected from guar, diutan, xanthan, hydroxyethylcellulose, carboxymethyl cellulose, carboxymethylhydroxypropyl guar, and so on, including combinations thereof. In some embodiments, the polymer is crosslinked. In some embodiments, the degradation comprises contacting the viscosifying agent with a degradation agent selected from oxidants, acids, and combinations thereof. In some embodiments, the degradation comprises heating the viscosifying agent to a degradation temperature. In some embodiments, the method further comprises degrading the fibers downhole, e.g., after initiating degradation of the viscosifying agent. In some embodiments, the method comprises contacting the fibers with an alkaline agent to degrade the fibers.

In some embodiments of the method, the treatment fluid further comprises a non-keratinolytic amount of an agent selected from crosslinking agents, such as borate, zirconium, aluminum or the like; crosslinking delay agents, such as sorbitol; gel stabilizers such as thiosulfate; breakers; and so on, including combinations thereof.

In some embodiments, the method comprises injecting a treatment fluid into a wellbore to form a fracture in a subterranean formation; placing keratin fibers in the fracture; and introducing an acid solution into the fracture. In some embodiments, the method comprises thereafter introducing an alkaline solution into the fracture to degrade the fibers.

### Embodiments Listing

Accordingly, the present disclosure provides the following embodiments, among others:

E1. A treatment fluid, comprising a plurality of fibers comprising fibrous structural protein.

E2. The treatment fluid of embodiment E1, wherein the fibers comprise keratin derived from one or more synthetic sources, one or more mammalian sources, or a combination thereof.

E3. The treatment fluid of embodiment E1 or E2, wherein the fibers comprise a substituted keratin, an unsubstituted keratin, a partially hydrolyzed keratin, or a combination thereof.

E4. The treatment fluid of any one of embodiments E1-E3, wherein the fibers have an average particle size distribution from 0.1 mm to 100 mm.

E5. The treatment fluid of any one of embodiments E1-E4, wherein the fibers comprise an average aspect ratio greater than or equal to about 5 or from about 5 to about 10,000.

E6. The treatment fluid of any one of embodiments E1-E5, wherein the fibers have an average length from about 0.1 mm to about 100 mm.

E7. The treatment fluid of any one of embodiments E1-E6, further comprising a dispersant, a surfactant, a viscosifier, a viscoelastic surfactant, a defoamer, a pH control agent, a cross-linker, a cross-linking delay agent, a gel stabilizer, an emulsion, a breaker, a fiber decomposition material, or a combination thereof.

E8. The treatment fluid of any one of embodiments E1-E7, comprising guar, diutan, xanthan, hydroxyethylcellulose, carboxymethyl cellulose, carboxymethylhydroxypropyl guar, or a combination thereof.

E9. The treatment fluid of any one of embodiments E1-E8, further comprising a proppant.

E10. The treatment fluid of any one of embodiments E1-E9, comprising an Apollonianistic solids mixture, wherein at least one particle size distribution mode comprises the fibers.

E11. The treatment fluid of embodiment E10, wherein the Apollonianistic solids mixture comprises first and second particle size distribution modes wherein the first particle size distribution mode is from 1.5 to 2.5 times larger than the second particle size distribution mode and wherein the first PSD mode is smaller than a PSD mode of a proppant.

E12. The treatment fluid of any one of embodiments E1-E11, comprising a foam, an energized fluid, or a combination thereof.

E13. The treatment fluid of embodiment E12, wherein the foam comprises a gas component selected from the group consisting of nitrogen, air, carbon dioxide, hydrocarbons, and mixtures thereof.

E14. The treatment fluid of embodiment E13, wherein the gas component comprises from about 5 volume percent to about 95 volume percent of the treatment fluid.

E15. A treatment fluid optionally in accordance with any one of embodiments E1-E14, comprising structural protein fibers and proppant in a viscous carrier fluid.

E16. The treatment fluid of embodiment E15, wherein the fibers comprise synthetic or mammalian keratin or a combination thereof.

E17. The treatment fluid of embodiment E15 or embodiment E16, wherein the fibers comprise substituted keratin, unsubstituted keratin, partially hydrolyzed keratin, or a combination thereof.

E18. The treatment fluid of any one of embodiments E15-E17, further comprising a dispersant, a surfactant, a viscosifier, a viscoelastic surfactant, a defoamer, a pH control agent, a cross-linker, a cross-linking delay agent, a gel stabilizer, a breaker, a fiber degradation agent, or a combination thereof.

E19. The treatment fluid of any one of embodiments E15-E18, comprising an Apollonianistic solids mixture, wherein at least one particle size distribution mode comprises the fibers.

E20. The treatment fluid of any one of embodiments E15-E19, comprising a foam, an energized fluid, or a combination thereof.

E21. The treatment fluid of any one of embodiments E15-E20, comprising an emulsion.

E22. A method comprising introducing the treatment fluid of any one of embodiments E1-E21 into a wellbore.

E23. A method, comprising:
dispersing a plurality of fibers comprising fibrous structural protein in a carrier fluid to form a treatment fluid; and
passing the treatment fluid downhole through a wellbore.

E24. The method of embodiment E22 or E23, further comprising transporting another solid in the treatment fluid.

E25. The method of any one of embodiments E22-E24, further comprising dispersing a degradable material into the treatment fluid, and selectively degrading one of the degradable material and the fibers downhole.

E26. The method of any one of embodiments E22-E25, further comprising dispersing a degradable material into the treatment fluid, selectively degrading one of the degradable material and the fibers downhole, and then degrading the other one of the degradable material and the fibers.

E27. The method of any one of embodiments E22-E26, wherein the fibers comprise partially hydrolyzed keratin to viscosify the treatment fluid.

E28. A method, optionally in accordance with any one of embodiments E22-E27, comprising:
passing downhole through a wellbore a treatment fluid comprising keratin fibers, proppant and a viscosifying agent in a carrier fluid; and
degrading the viscosifying agent downhole.

E29. The method of embodiment E28, further comprising distributing a mixture of the fibers and proppant into one or more regions in a fracture, wherein the viscosifying agent induces in situ channelization to aggregate the mixture into pillars in the one or more regions separated by channels.

E30. The method of embodiment E28, comprising uniformly distributing a mixture of the fibers and proppant into one or more regions in a fracture, wherein the viscosifying agent induces in situ channelization to aggregate the mixture into pillars in the one or more regions separated by channels.

E31. The method of any one of embodiments E28-E30, further comprising producing reservoir fluid through the channels between pillars of the aggregated mixtures.

E32. The method of any one of embodiments E28-E30, further comprising producing reservoir fluid through the channels between pillars of the aggregated mixtures without degrading the fibers.

E33. The method of any one of embodiments E28-E32, further comprising forming a proppant pack comprising the fibers, and degrading the fibers to increase permeability of the proppant pack.

E34. The method of any one of embodiments E28-E33, wherein the viscosifying agent comprises a polymer selected from guar, diutan, xanthan, hydroxyethylcellulose, carboxymethyl cellulose, carboxymethylhydroxypropyl guar, and combinations thereof.

E35. The method of any one of embodiments E28-E34, wherein the polymer is crosslinked.

E36. The method of any one of embodiments E28-E35, wherein the degradation comprises contacting the viscosifying agent with a degradation agent selected from oxidants, acids, and combinations thereof.

E37. The method of any one of embodiments E28-E36, wherein the degradation comprises heating the viscosifying agent to a degradation temperature.

E38. The method of any one of embodiments E28-E37, further comprising degrading the fibers downhole.

E39. The method of any one of embodiments E28-E38, further comprising contacting the fibers with an alkaline agent to degrade the fibers.

E40. The method of any one of embodiments E28-E39, wherein the treatment fluid further comprises a non-keratinolytic amount of an agent selected from crosslinking agents, crosslinking delay agents [such as sorbitol], gel stabilizers [such as thiosulfate], breakers, and combinations thereof.

E41. The method of any one of embodiments E28-E40, wherein the treatment fluid further comprises a non-keratinolytic amount of a crosslinking agent selected from borates, zirconium, aluminum, and combinations thereof.

E42. The method of any one of embodiments E28-E41, wherein the treatment fluid further comprises a non-keratinolytic amount of a crosslinking delay agent, preferably sorbitol.

E43. The method of any one of embodiments E28-E42, wherein the treatment fluid further comprises a non-keratinolytic amount of a gel stabilizers, preferably thiosulfate.

E44. The method of any one of embodiments E28-E42, wherein the treatment fluid further comprises a breaker.

E45. A method, optionally in accordance with any one of methods E22-E44, comprising:
injecting a treatment fluid into a wellbore to form a fracture in a subterranean formation;
placing keratin fibers in the fracture; and
introducing an acid solution into the fracture.

E46. The method of embodiment E45, further comprising thereafter introducing an alkaline solution into the fracture to degrade the fibers.

E47. A method, optionally in accordance with any one of methods E22-E46, comprising dispersing a plurality of fibers comprising fibrous structural protein in a carrier fluid to produce a treatment fluid; and circulating the treatment fluid into a wellbore.

E48. The method of embodiment E47, further comprising introducing Apollonianistic solids into the treatment fluid.

E49. The method of any one of embodiments E47-E48, further comprising forming a pack of the solids in the wellbore.

E50. The method of any one of embodiments E47-E49, wherein the pack comprises proppant and at least one particle size distribution mode comprising the fibers.

E51. The method of embodiment E50, further comprising removing at least a portion of the fibers from the pack to form a permeable proppant pack.

E52. The method of embodiment E51, further comprising producing or injecting a fluid through the permeable proppant pack.

E53. The method of embodiment E52, wherein the permeable proppant pack is disposed in a fracture.

### EXAMPLES

Bio-fibers were evaluated for proppant carrying ability in typical proppant containing treatment fluids. Keratin fibers derived from human hair were dispersed in a cross-linked treatment fluid comprising proppant at a concentration of 40 ppt (pounds per thousand gallons clear liquid). The keratin fibers demonstrated the ability to both anchor and suspend proppant.

A viscosity breaker was then added to the treatment fluid. Once again, the keratin fibers demonstrated the ability to support and anchor the proppant even in the broken fluid. This property is beneficial in many applications, such as in situ channelization.

These examples confirm the ability of animal based bio-fibers such as keratin to assist in the transport of proppant in subterranean treatment in oilfield applications. In particular for fracturing fluids, cementing, drilling fluid, sand control and the like. Accordingly, bio-fibers such as keratin are suitable for use to assist in transport of proppant, or prevent proppant flowback, for use in in-situ channelization, plugging perforation tunnels, as additives for diversion, and the like. In addition a partially hydrolyzed keratin fiber may play a dual function as a viscosity creating agent.

In embodiments, the keratin fibers may be used as part of a diverting pill such as the ones disclosed in U.S. Pat. No. 8,905,133 incorporated herein in its entirety and be degraded with time or an alkaline solution can be injected downhole to destabilize the plug and/or degrade the fibers.

The keratin fibers were evaluated for decomposition or dissolution in the presence of an oxidizing agent and in an acidic environment. The keratin fibers did not degrade after 2 days of contact with an oxidizer solution comprising 0.06% ammonium persulfate at 25° C., or after 2 days of contact with a 7.5% HCl solution at 25° C. The stability of keratin demonstrates the suitability of keratin in various oilfield applications where aggressive fluids are used e.g. acid treatments in carbonate formations or acid used in unconventional shale gas formations. Also, in application for in-situ channelization, it is beneficial to maintain fiber integrity while breaking the carrier fluid, which is usually done with an oxidizing breaker such as ammonium persulfate.

The keratin fibers were evaluated for decomposition or dissolution in the presence of alkaline solutions such as sodium hydroxide. The keratin fibers were entirely degraded and completely dissolved after 2 days of contact with 30% sodium hydroxide at 25° C. This attribute is very beneficial, as it allows for very effective cleanup of fibers. These examples demonstrate an appropriate time frame of degradation may occur after fracture closure. These examples further suggest that the degradation time may be controlled by selecting the concentration of the degradation material and or the fibers. The slow degradation of the fibers is beneficial: As these experiments confirm, the keratin fibers can support the proppant during pumping, and then may be dissolved after job completion, resulting in an increased permeability of the proppant pack during production. Accordingly, the use of keratin fibers leads to increased conductivity and production for the entire fracture. This is especially beneficial when fibers are utilized, especially for in situ channelization, wherein the keratin fibers will allow for improved conductivity through the proppant pillars in addition to the channels formed.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A method, comprising:
dispersing a plurality of fibers comprising fibrous structural protein in a carrier fluid to form a treatment fluid; and
passing the treatment fluid downhole through a wellbore.

2. The method of claim 1, further comprising transporting another solid in the treatment fluid.

3. The method of claim 1, further comprising dispersing a degradable material into the treatment fluid, and selectively degrading one of the degradable material and the fibers downhole.

4. The method of claim 1, further comprising dispersing a degradable material into the treatment fluid, selectively degrading one of the degradable material and the fibers downhole, and then degrading the other one of the degradable material and the fibers.

5. The method of claim 1, wherein the fibers comprise partially hydrolyzed keratin to viscosify the treatment fluid.

6. A method, comprising:
passing downhole through a wellbore a treatment fluid comprising keratin fibers, proppant and a viscosifying agent in a carrier fluid; and
degrading the viscosifying agent downhole.

7. The method of claim 6, further comprising distributing a mixture of the fibers and proppant into one or more regions in a fracture, wherein the viscosifying agent induces in situ channelization to aggregate the mixture into pillars in the one or more regions separated by channels.

8. The method of claim 7, further comprising producing reservoir fluid through the channels between pillars of the aggregated mixtures.

9. The method of claim 6, further comprising forming a proppant pack comprising the fibers, and degrading the fibers to increase permeability of the proppant pack.

10. The method of claim 6, wherein the viscosifying agent comprises a polymer selected from guar, diutan, xanthan, hydroxyethylcellulose, carboxymethyl cellulose, carboxymethylhydroxypropyl guar, and combinations thereof.

11. The method of claim 10, wherein the polymer is crosslinked.

12. The method of claim 6, wherein the degradation comprises contacting the viscosifying agent with a degradation agent selected from oxidants, acids, and combinations thereof.

13. The method of claim 6, wherein the degradation comprises heating the viscosifying agent to a degradation temperature.

14. The method of claim 6, further comprising degrading the fibers downhole.

15. The method of claim 6, further comprising contacting the fibers with an alkaline agent to degrade the fibers.

16. The method of claim 6, wherein the treatment fluid further comprises a non-keratinolytic amount of an agent selected from crosslinking agents, crosslinking delay agents, gel stabilizers, breakers, and combinations thereof.

17. A method, comprising:
injecting a treatment fluid into a wellbore to form a fracture in a subterranean formation;
placing keratin fibers in the fracture; and
introducing an acid solution into the fracture.

18. The method of claim 16, further comprising thereafter introducing an alkaline solution into the fracture to degrade the fibers.

19. A treatment fluid, comprising structural protein fibers and proppant in a viscous carrier fluid.

20. The treatment fluid of claim 19, wherein the fibers comprise synthetic or mammalian keratin or a combination thereof.

21. The treatment fluid of claim 19, wherein the fibers comprise substituted keratin, unsubstituted keratin, partially hydrolyzed keratin, or a combination thereof.

22. The treatment fluid of claim 19, further comprising a dispersant, a surfactant, a viscosifier, a viscoelastic surfactant, a defoamer, a pH control agent, a cross-linker, a cross-linking delay agent, a gel stabilizer, a breaker, a fiber degradation agent, or a combination thereof.

23. The treatment fluid of claim 19, comprising an Apollonianistic solids mixture, wherein at least one particle size distribution mode comprises the fibers.

24. The treatment fluid of claim 19, comprising a foam, an energized fluid, or a combination thereof.

25. The treatment fluid of claim 19, comprising an emulsion.
